(19) United States
(12) Patent Application Publication
(10) Pub. No.: US 2006/0168837 A1
(43) Pub. Date: Aug. 3, 2006

(54) Zero set scale

(76) Inventor: Arthur M. Muir, Natrona Heights, PA (US)

Correspondence Address: ANDREW ALEXANDER & ASSOCIATES, 3124 KIPP AVENUE, P.O. BOX 2038, LOWER BURRELL, PA, 15068, US

(21) Appl. No.: 11/047,507

(22) Filed: Feb. 1, 2005

(51) Int. Cl. G01D 21/00

(52) U.S. Cl. 33/710

(57) ABSTRACT

Disclosed is a zero set scale for measuring linear travel of a machine table or spindle, the scale comprised of a support member and two opposed rollers mounted on the support member. A continuous belt having a numerical scale thereon is mounted on the support rollers, the rollers spaced apart sufficient to apply slight tension to the belt, the numerical scale extending in opposite directions from a zero point. An indicator is mounted in cooperation with the belt to permit the scale to be set to the zero point or required measurement. Fastener means is provided for mounting the zero set scale to a machine.

### BACKGROUND OF THE INVENTION

This invention relates to an instrument for measurement and more particularly it relates to a device which permits repeated measurements on a milling machine or drill press as it is moved along a workpiece, thereby assuring repeatability of machining or drilling, for example. That is, this invention relates to precise measurement or depth of blind holes, for example, as holes are drilled in different workpieces.

It is well known that there are sophisticated measuring devices for use with milling machines and drill presses. One such device utilizes a digital readout and is basically electronic. Such devices normally use a slider which passes over a scale having impulse generating markings on it. The slider reads the markings and utilizing its mini-computer card, displays the information on a digital display, thereby showing the position of the slider. This, in turn, shows the position of the workpiece mounted on the same device as the slider. Such devices are disclosed, for example, U.S. Pat. No. 4,238,885 which describes an instrument for the measurement and verification of linear dimensions including a body equipped with external and internal feelers, a perch mounted in a slideway in the body and equipped with external and internal feelers cooperating with those of the body, and independent depth gauge mounted in a second slideway of the body, and a feeler rod mounted in a third slideway of the body, and cooperating with a contact piece fastened with an inner face of the external feeler of the perch. A movable member of a measurement transducer is selectively connected to the perch, to the gauge and to the feeler rod by a selective coupling device. In turn, a display device with zeroing control is connected to the measurement transducer. In a single apparatus, the subject instrument is capable of measuring and verifying different linear dimensions, such as for instance, the diameter of a shaft, the depth of a blind hole, the length of a shaft or groove, or any reduction of a diameter of a finished part or a part in the course of manufacturing. However, this device has the disadvantage that it requires a large investment.

Thus, there is a great need for a simple instrument which can be retrofitted to machines that permits the operator to obtain precise measurements with consistency. The present invention provides such an instrument.

### SUMMARY OF THE INVENTION

It is an object of his invention to provide zero set scale which can be retrofitted to existing machines such as milling machines and drill presses.

It is another object of the invention to provide an instrument which permits a machinist to produce same-depth machining regardless of thickness or configuration of the workpiece.

Yet, it is another object of the invention to provide a zero set scale which may be used on a milling machine in the horizontal or vertical direction.

In accordance with these objects there is disclosed a zero set scale for measuring linear travel of a machine table or spindle, the scale comprised of a support member and two opposed rollers mounted on the support member. A continuous belt having a numerical scale thereon is mounted on the support rollers, the rollers spaced apart sufficient to apply slight tension to the belt, the numerical scale extending in opposite directions from a zero point. An indicator is mounted in cooperation with the belt to permit the scale to be set to the zero point or required measurement. Fastener means is provided for mounting the zero set scale to a machine.

### BRIEF DESCRIPTION OF THE DRAWINGS

FIG. 1 is a perspective view of a zero set scale in accordance with the invention.

FIG. 2 is a front elevational view of the zero set scale of FIG. 1.

FIG. 3 is a cross-sectional view showing the rollers and slide mechanism of one roller.

FIG. 4 is a cross-sectional view showing the rollers and spring means to maintain tension on the endless belt.

FIG. 5 is a schematic illustrating a milling machine and the location of the zero set scale.

### DETAILED DESCRIPTION OF PREFERRED EMBODIMENTS

Referring now to FIG. 1, there is illustrated zero set scale 2 of the invention. Embodiment 2 comprises a support or frame member 4 having a bottom member 6 and a back member 8. In FIG. 1 on back member 8 is mounted rollers 10 and 12. An endless belt 14 is mounted on rollers 10 and 12. A guide block 11 is provided on which endless belt 14 can rest. That is, guide block 11 provides support for the endless belt. Endless belt 14 is provided with a numerical scale extending in both directions from a zero point. Roller 12 is provided with a knob 16 which is used to turn or adjust belt 14, thereby adjusting the scale to a new zero set point. It will be noted that endless belt 14 can be turned in a clockwise or counter-clockwise direction. Thus, a new zero point may be obtained as the workpiece is moved along a work table.

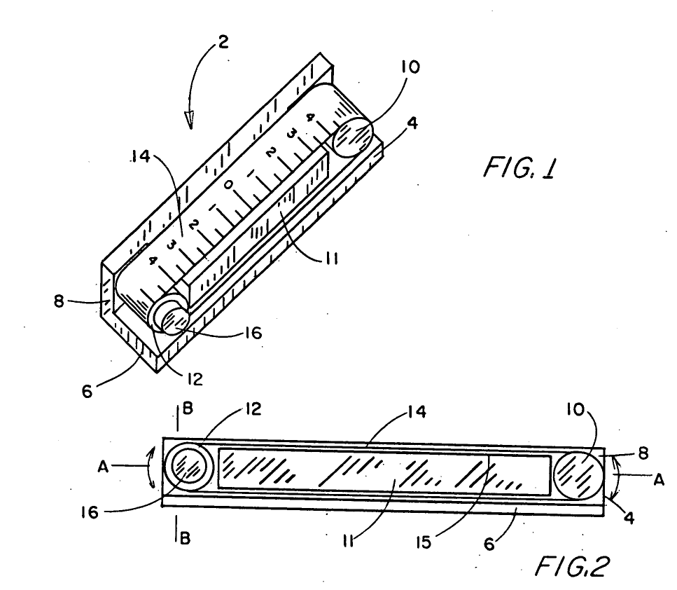

FIG. 2 is a frontal view of the zero point scale showing the support member 4 with guide block 11 and endless belt 14 disposed between rollers 10 and 12.

It will be noted that belt 14 rides on or is supported by surface 15 of block 11. Further, it will be seen that endless belt 14 is stretched between rollers 10 and 12 to provide slight tension on the belt, and the belt may be turned backwards or forwards by knob 16 on roller 12.

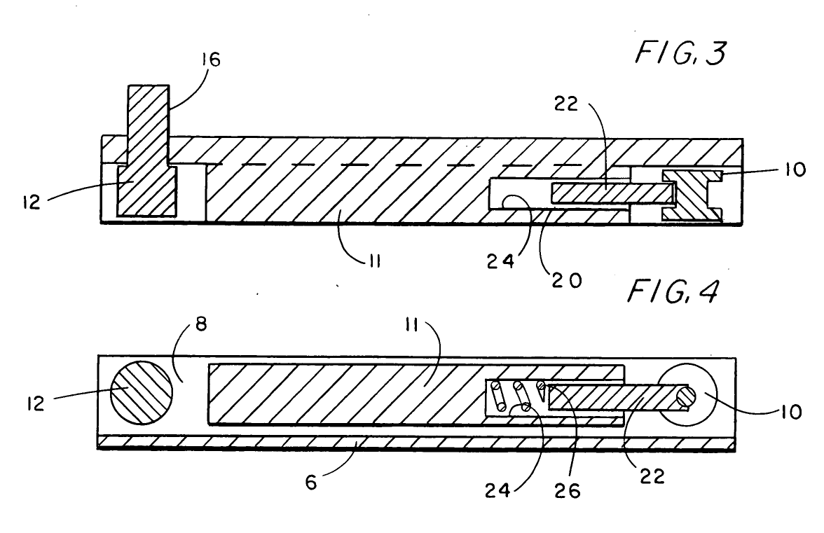

Referring to FIG. 3, there is shown a cross-sectional view along the line A-A of FIG. 2. In this view, there is shown sliding means 20 for adapting to maintain tension on belt 14. It will be seen in FIG. 3 that roller 10 is mounted on arm member 22 which can slide back and forth in recess 24. As will be seen in FIG. 4, which is a cross section along the line B-B of FIG. 2, a spring 26 provided in recess 24 can provide sufficient pressure on roller 10 to apply the desired amount of tension on belt 14.

The support member 4 can be fabricated out of metal or plastic and the rollers are preferably fabricated from a rubberous material to provide friction with belt 14. Further, preferably belt 14 is made from a thin steel material on which the numerical scale can be etched, for example.

The zero set scale can be used with different machines to provide the operator with same depth blind holes, for example, regardless of the level of the surface or changes in thickness of the workpiece. For example, if the surface is stepped, the zero set scale permits the operator to obtain the same depth blind hole by setting the scale to zero for each new surface level. Thus, it will be understood that the zero set scale can be used vertically or horizontally and be used on milling machines, drill presses, lathes, boring mills, surface grinders, and height gauges.

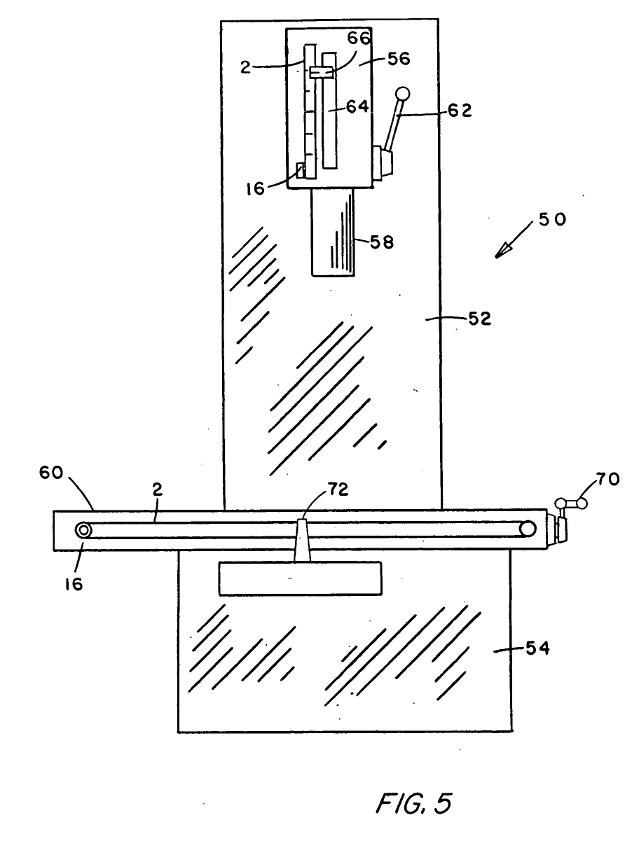

FIG. 5 illustrates the use of the zero set scale on a milling machine 50 on which there is illustrated a back support 52 and a base 54. Mounted on the back support 52 is spindle housing 56 containing spindle 58. Milling head (not shown) can be mounted to spindle 58. Workpiece (not shown) is placed on table 60 and spindle 58 is moved upwardly and downwardly using handle 62. Zero set scale 2 is shown attached or mounted to housing 56. Housing 56, as shown, has a slot 64 to permit indicator 66 to travel up and down with spindle 58. The zero set scale can be adjusted by knob 16. Thus, for illustrative purposes, in the embodiment shown in FIG. 5, if the workpiece is stepped and it is desired to drill blind holes of the same depth in each step, this is easily accomplished by setting pointer 66 to zero on the scale at each step level and drilling to the appropriate depth. Thus, there is no need to make measurements or adding and subtracting to obtain the measurements for drilling. That is, the zero set scale greatly simplifies the drilling operation and yet provides accuracy for the depth of the blind holes.

Similarly, the zero set scale may be used in the horizontal position, as shown in FIG. 5. As noted, 60 refers to the horizontal table and 54 refers to the table support. The zero set scale is shown substantially in the horizontal position and knob 16 is provided to set the scale to zero as required. Handle 70 provides for adjustment of the table by means of a screw member attached to the table that is passed through a nut attached to the base. A pointer or indicator 72 stationary to the base is illustrated for showing the location of the table as the scale passes the indicators.

Having described the presently preferred embodiments, it is to be understood that the invention may be otherwise embodied within the scope of the appended claims.

What is claimed is:

1. A zero set scale for measuring linear travel of a machine table or spindle, the scale comprised of:
(a) a support member;
(b) two opposed rollers mounted on said support member;
(c) a continuous belt having a numerical scale thereon, mounted on said support rollers, said rollers spaced apart sufficient to apply slight tension to said belt, said numerical scale extending in opposite directions from a zero point;
(d) an indicator mounted in cooperation with said belt to permit said scale to be set to said zero point or required measurement; and
(e) fastener means for mounting said zero set scale to a machine.

2. The scale in accordance with claim 1 wherein said continuous belt is fabricated from a metal.

3. The scale in accordance with claim 1 wherein said continuous belt is fabricated from a steel.

4. The scale in accordance with claim 1 wherein said rollers are comprised of a rubberous material.

5. The scale in accordance with claim 1 wherein one of said rollers comprises means for rotating said belt.
